(19) United States
(12) Patent Application Publication
(10) Pub. No.: US 2003/0106401 A1
(43) Pub. Date: Jun. 12, 2003

(54) Method and apparatus for making tongue and groove joints

(76) Inventor: Daniel G. Kowalski, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/313,092

(22) Filed: Dec. 5, 2002

(30) Foreign Application Priority Data
Dec. 6, 2001 (CA) 2,364,641

(51) Int. Cl. B26D 1/00; B26D 3/06

(52) U.S. Cl. 83/13; 83/875

(57) ABSTRACT

An apparatus for making tongue and groove joints which includes a handle having a gripping end and an attachment end. A drive motor is disposed within the handle. An output shaft extends perpendicular to the handle at the attachment end. A cutting guide overlies the output shaft. The cutting guide has a first step which is planar so as to rest upon a flat working surface, a second step and a riser that extends between the first step and the second step. This riser is perpendicular to the first step. A cutting blade is rotatably mounted on the output shaft and projects from the riser parallel to the first step and in an intermediate position between the first step and the second step. The blade is adapted to cut a groove of a selected depth and width in a board.

### FIELD OF THE INVENTION

The present invention relates to a method and an apparatus for making tongue and groove joints; in particular with reference to wood framing and wood flooring.

### BACKGROUND OF THE INVENTION

Tongue and groove flooring comes in standard lengths and widths. A tongue extends for a length of each board along a first side and a groove extends for the length of each board along a second side. A tongue projects from a first end of each board and a groove is positioned at a second end of each board. As each board is installed the tongue on the first side of one board is inserted into the groove on the second side of an adjacent board; and a tongue at the first end of the first board is inserted into the groove at the second end of an abutting board.

Problems arise whenever one must patch an existing floor or when there is a change in direction in a new floor. A change in direction occurs when there is a border around a room or when a floor in one room has to be tied into to a floor in an adjoining room that runs in a different direction. In such cases it is difficult to maintain tongue and groove engagements. As boards are cut to fit, either the tongue must be cut from the first end or the groove must be cut from the second end. If the workman does not maintain tongue and groove engagements, one of the ends of the boards is not interlocked with the remainder of the floor and may lift. This problem is particularly acute with “floating” floors that are not directly secured to a subfloor.

### SUMMARY OF THE INVENTION

What is required is a method and an apparatus for making tongue and groove joints that addresses this problem.

According to one aspect of the present invention there is provided an apparatus for making tongue and groove joints which includes a handle having a gripping end and an attachment end. A drive motor is disposed within the handle. An output shaft extends perpendicular to the handle at the attachment end. A cutting guide overlies the output shaft. The cutting guide has a first step which is planar so as to rest upon a flat working surface, a second step and a riser that extends between the first step and the second step. This riser is perpendicular to the first step. A cutting blade is rotatably mounted on the output shaft and projects from the riser parallel to the first step and in an intermediate position between the first step and the second step. The blade is adapted to cut a groove of a selected depth and width in a board.

As will hereinafter be further described, this apparatus is suited for placing a groove in a side or end of any board that is resting upon a stable surface such as a floor. It is also capable of placing a groove in a board that has already been secured down to form part of a floor. It is also capable of putting a groove in a board that has been cut at an angle to fit unusual installation configurations.

According to another aspect of the invention there is provided a method for making tongue and groove joints. A first step involves providing the apparatus described above. A second step involves positioning the first step of the cutting guide against the flat working surface and a board between the flat working surface and the second step of the cutting guide. A third step involves moving the cutting guide along the board to cause the cutting blade to cut a groove in the board.

This enables grooves to be placed in boards during installation or when effecting repairs. Of course, in tongue and groove flooring there are two mating components tongues and grooves. To this point the absence of a groove has been addressed, but not the absence of a tongue. In the absence of a tongue a first groove is cut into a first board and a second groove is cut into a second board. The first board and the second board are then joined by inserting a spline into the first groove and the second groove.

Although beneficial results may be obtained through the use of the apparatus, as described above, for tongue and groove flooring; with a minor modification the apparatus may be adapted for use with a number of other tongue and groove joint applications. According to this aspect of the invention, the second step is divided into two portions: a support and a detachable shoe which is detachably secured to the support. The angle of the second step relative to the riser is adjustable by selecting the detachable shoe with a board engaging surface oriented at a desired angle. This means that the apparatus can be adapted to a variety of angular applications by changing detachable shoe.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of an apparatus for making tongue and groove joints constructed in accordance with the teachings of the present invention.

FIG. 2 is a top plan view of the apparatus for making tongue and groove joints illustrated in FIG. 1.

FIG. 3 is a bottom plan view of the apparatus for making tongue and groove joints illustrated in FIG. 1.

FIG. 4 is a bottom perspective view of the apparatus for making tongue and groove joints illustrated in FIG. 1.

FIG. 5 is a detailed top plan view of a cutting blade from the apparatus for making tongue and groove joints illustrated in FIG. 1.

FIG. 6 is a side elevation view of the apparatus for making tongue and groove joints illustrated in FIG. 1.

FIG. 7 is a side elevation view of two boards joined together by a spline in accordance with the teaching of the method.

FIG. 8 is a side elevation view of a second embodiment of apparatus for making tongue and groove joints, which has the added feature of a detachable shoe.

### DETAILED DESCRIPTION OF THE PREFERRED EMBODIMENT

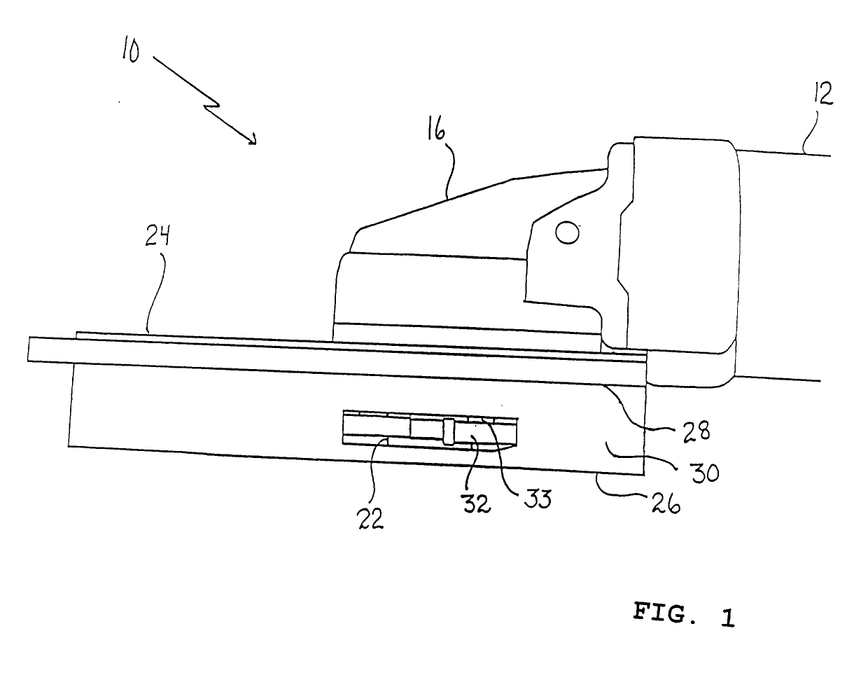

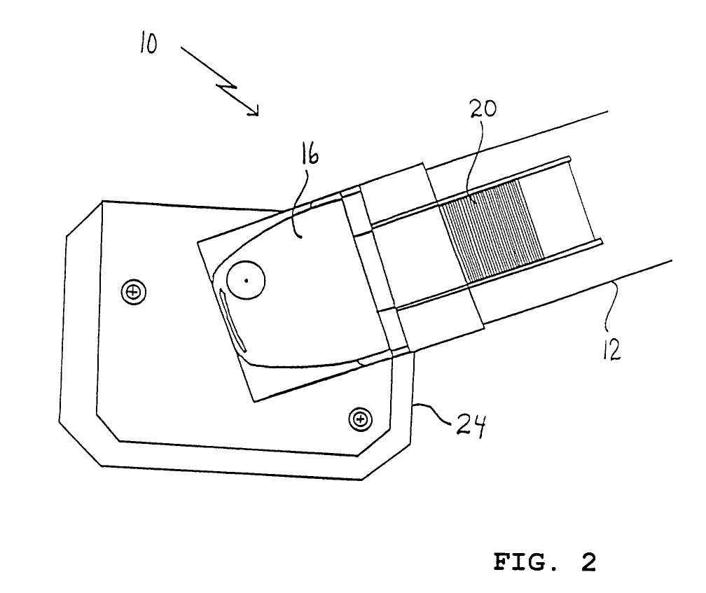

The preferred embodiment, an apparatus for making tongue and groove joints generally identified by reference numeral 10, will now be described with reference to FIGS. 1 through 7.

Structure and Relationship of Parts:

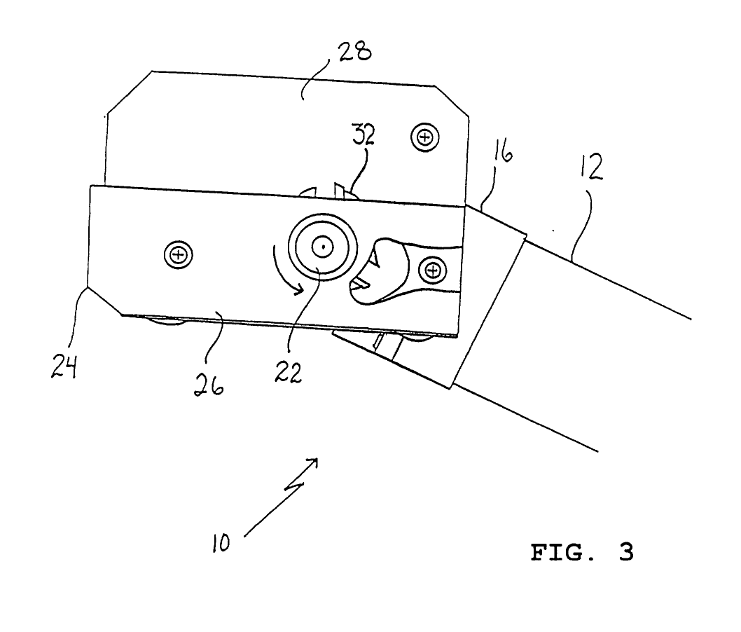

Referring to FIG. 1, apparatus 10 includes a handle 12 with a gripping end 14 and an attachment end 16. A drive motor 18 disposed within handle 12. A switch 20 is provided on handle 12 for activating drive motor 18. Referring to FIGS. 1 and 3, an output shaft 22 extends perpendicular to handle 12 at attachment end 16. A cutting guide 24 overlies output shaft 22. Referring to FIG. 1, cutting guide 24 has a planar first step 26, a planar second step 28 and a riser 30 that extends perpendicularly between first step 26 and second step 28.

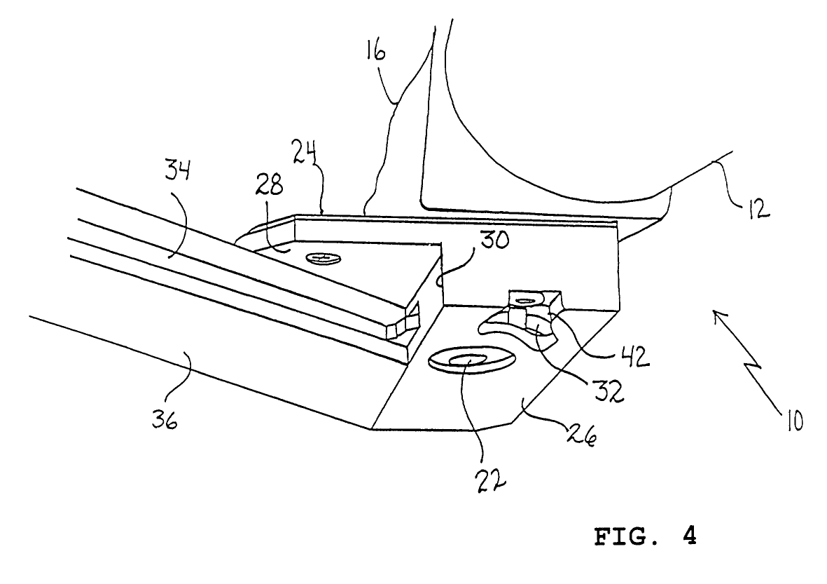

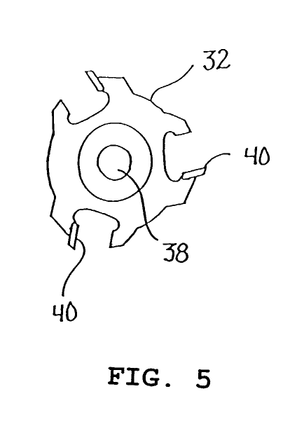

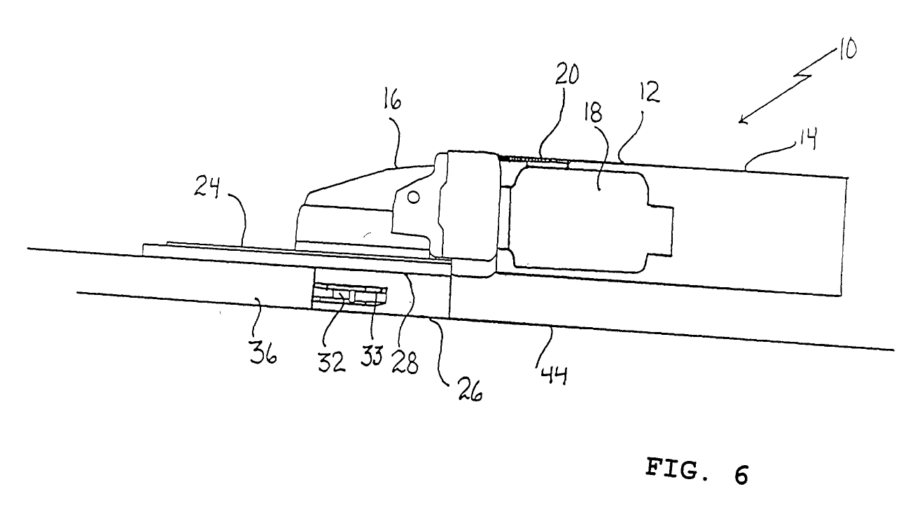

A cutting blade 32 is rotatably mounted on output shaft 22 and projects from riser 30 parallel to and in an intermediate position between first step 26 and second step 28. It is sometimes necessary to adjust of the positioning of cutting blade 32 between first step 26 and second step 28 in order to accommodate differences in boards 36 originating from different manufacturers. Referring to FIG. 6, such adjustments are accomplished by the addition of shim washers 33 to adjust the positioning of cutting blade 32. Referring to FIG. 4, cutting blade 32 is adapted to cut a groove 34 of a selected depth and width in a board 36. Referring to FIG. 5, in the illustrated embodiment, cutting blade 32 has a central aperture 38 for receiving output shaft 22, and a plurality of cutting edges 40. Referring to FIG. 4, an opening 42 is provided in first step 26 to allow access to cutting blade 32 in order to clear out accumulated debris. Referring to FIG. 6, it is preferred that the length of riser 30 be sufficient to provide an aligning edge which assists in feeding board 36 into cutting blade 32. The shorter the length of riser 30 leading into cutting blade 32, the more difficult it becomes to feed board 36 as cutting blade 32 will tend to “kick back” board 36.

Operation:

The use and operation of apparatus 10 in accordance with the preferred method for making tongue and groove joints will now be described in use with a tongue and groove flooring application with reference to FIGS. 1 through 7. Referring to FIG. 1, apparatus 10 as described above, is provided during installation or when effecting repairs for placing grooves 34 in boards 36 that are resting on a stable surface such as a floor 44 or boards 36 which have already been secured down to form part of a floor 44. To do so, first step 26 of cutting guide 24 is positioned against floor 44 with board 36 positioned between floor 44 and second step 28 of cutting guide 24. Referring to FIGS. 4 and 6 switch 20 is used to activate apparatus 10 and cutting guide 24 is then moved along board 36 to cause cutting blade 32 to cut groove 34 in board 36. The operation is performed with one hand holding board 36 in position and the other hand controlling apparatus 10. Referring to FIG. 4, apparatus 10 is also capable of putting groove 34 in board 36 where board 36 has been cut at an angle to fit unusual installation configurations.

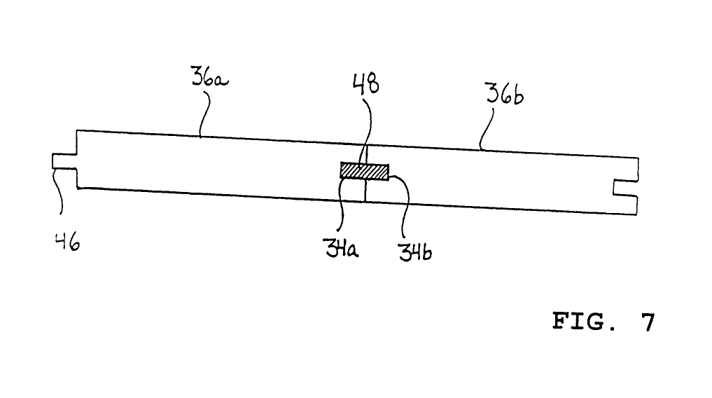

Referring to FIG. 7, for the purpose of this description, two boards 36 are provided which are labelled as first board 36a and second board 36b. Most boards have a mating components which include a tongue 46 and groove 34. Using apparatus 10 boards can be joined which have neither a tongue or a groove. A first groove 34a is cut into first board 36a and a second groove 34b is cut into second board 36b. First board 36a and second board 36b are then joined by inserting a spline 48 into first groove 34a and second groove 34b.

Referring to FIG. 4, during cutting of grooves 34, accumulated debris may interfere with operation of cutting blade 32. Opening 42 in first step 26 allows for the removal of accumulated debris. Through the use of the method and apparatus described above practically every board in a tongue and groove floor can be effectively interlocked against vertical movement.

Variations:

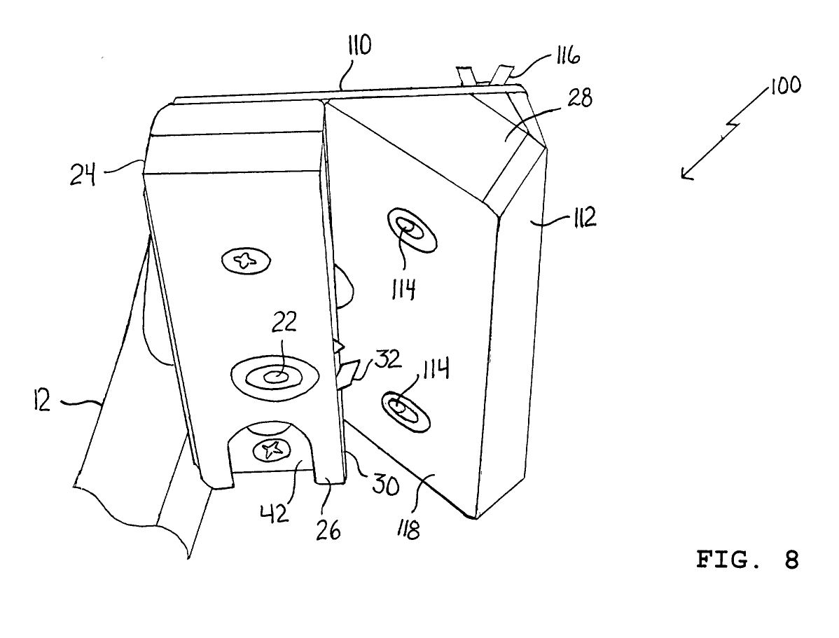

Although beneficial results may be obtained through the use of the apparatus, as described above, for planar applications, such as tongue and groove flooring; the apparatus may be adapted for use with tongue and groove joint applications in corner joints. For example, to make a 90 degree corner, each piece that is joined must be cut at an acute angle of 45 degrees. Similarly, to make a 120 degree corner, each piece that is joined must be cut at an acute angle of 60 degrees. Referring to FIG. 8, there is illustrated a second embodiment of the invention generally identified by reference numeral 100. Except as otherwise described, apparatus 100 is identical to apparatus 10. As such, the same reference numerals will be used in FIG. 8, to identify the identical components as has been used in relation to the description of apparatus 10. The only difference lies in the construction of second step 28 on cutting guide 24. Second step 28 is divided into two portions: a support 110 and a detachable shoe 112. Detachable shoe 112 is detachably secured to support 110 by screws 114 and wingnuts 116. The angle of second step 28 relative to riser 30 is adjustable by selecting detachable shoe 112 with a board engaging surface 118 oriented at a desired angle. As described above, when the desired angle is planar or 180 degrees, board engaging surface 118 of detachable shoe 112 and riser 30 will describe a 90 degree angle. When the desired angle is 120 degrees, board engaging surface 118 of detachable shoe 112 and riser 30 will describe a 60 degree angle. In the illustrated embodiment, the angle between board engaging surface 118 of detachable shoe 112 and riser 30 is shown as 45 degrees, which is suitable for making a 90 degree or right angle corner. With this small modification, apparatus 100 can be adapted to make a wide variety of angular corner joints. The angle between board engaging surface 118 of detachable shoe 112 and riser 30 will always be equal to the desired acute angle of each of the pieces that join together to form the corner. By selecting detachable shoe 112 with a desired angle of board engaging surface 118, apparatus 100 can be adapted to cut an groove to facilitate a tongue and groove corner joint at virtually any desired angle.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. An apparatus for making tongue and groove joints, comprising:
a handle having a gripping end and an attachment end;
a drive motor disposed within the handle;
an output shaft extending perpendicular to the handle at the attachment end;
a cutting guide overlying the output shaft, the cutting guide having a first step which is planar so as to rest upon a flat surface, a second step and a riser that extends between the first step and the second step, the riser being perpendicular to the first step;
a cutting blade rotatably mounted on the output shaft and projecting from the riser parallel to the first step and in an intermediate position between the first step and the second step, the blade being adapted to cut a groove of a selected depth and width in a board.

2. The apparatus as defined in claim 1, wherein the second step has a support and a detachable shoe which is detachably secured to the support, such that the angle of the second step relative to the riser is adjustable by selecting the detachable shoe with a board engaging surface oriented at a desired angle.

3. A method for making tongue and groove joints, comprising the steps of:
providing an apparatus comprising:
a handle having a gripping end and an attachment end;
a drive motor disposed within the handle;
an output shaft extending perpendicular to the handle at the attachment end;
a cutting guide overlying the output shaft, the cutting guide having a first step which is planar so as to rest upon a flat working surface, a second step and a riser that extends between the first step and the second step, the riser being perpendicular to the first step;
a cutting blade rotatably mounted on the output shaft and projecting from the riser parallel to the first step and in an intermediate position between the first step and the second step, the blade being adapted to cut a groove of a selected depth and width in a board;
positioning the first step of the cutting guide against the flat working surface and a board between the flat working surface and the second step of the cutting guide;
moving the cutting guide along the board to cause the cutting blade to cut a groove in the board.

4. The method as defined in claim 3, the second step having a support and a detachable shoe which is detachably secured to the support, such that the angle of the second step relative to the riser is adjustable by selecting the detachable shoe with a board engaging surface oriented at a desired angle.

5. The method as defined in claim 3, wherein a first groove is cut into a first board, a second groove is cut into a second board, and the first board and the second board are joined by inserting a spline into the first groove and the second groove.
